(19) United States
(12) Patent Application Publication
(10) Pub. No.: US 2007/0254129 A1
(43) Pub. Date: Nov. 1, 2007

(54) Reusable storage patch

(76) Inventor: Andrea Horblitt, New York, NY (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/732,761

(22) Filed: Apr. 3, 2007

Related U.S. Application Data
(60) Provisional application No. 60/789,557, filed on Apr. 4, 2006.

(51) Int. Cl. B32B 33/00; B32B 3/06; B32B 9/00

(52) U.S. Cl. 428/42.3; 428/99; 428/100; 428/40.1

(57) ABSTRACT

The present invention relates to a reusable storage patch that includes a storage device with at least one compartment, and a plurality of adhesive layers coupled to the storage device. Each adhesive layer of the plurality of adhesive layers may be reusably affixable to at least one surface, and the plurality of adhesive layers may be each separated by a non-adhesive material. The storage device may include a flap extending at least partially over an opening of the at least one compartment, and the storage device may also include a closure mechanism configured to at least temporarily secure the flap to the storage device.

### CROSS-REFERENCE TO RELATED APPLICATIONS

This application claims benefit under 35 U.S.C. § 119(e) of U.S. Provisional Application No. 60/789,557 filed Apr. 4, 2006, which is hereby incorporated by reference in its entirety.

### BACKGROUND OF THE INVENTION

1. Technical Field

The present invention relates to a reusable storage patch that may be applied to an object, and selectively removed from the same.

2. Related Art

The common pocket, wallet and purses are well known, and are generally used to store and transport various personal belongings. Pockets are generally attached to an article of clothing or an object in order to provide means for storing personal accessories and other valuables. For example, pockets may be attached to clothing by means of sewing, snaps, buttons, or magnets. Wallets or other personal containers are generally placed within pockets, and include compartments to hold small personal accessories used for an individual's daily activities. Purses may have multiple compartments and means to securely close the compartments. However, pursues are generally too large to be placed within pockets, and must be carried separately by individuals.

While the common pocket, wallet and purse are widely used, there are various activities in which use of these devices may be difficult, or result in the loss of personal items. Activities in which the common pocket, wallet and purse have limited use include physical activities, i.e. gym or sports, nightlife and travel. For example, during travel activities one or more large and cumbersome suitcases may be carried. A traveler may have to search through multiple suitcases in order to find a desired personal item. In addition, articles of clothing normally associated with the gym or sporting activities generally do not have usable pockets to hold personal items, including wallets. An individual engaged in these activities may have to fix personal items, such as keys or money, to parts of their body or place their personal items in their socks.

Physical activities involving swimming or the beach pose particular problems for carrying personal items, because swim and beach attire offers, at best, limited pockets that are likely come into contact with water. Therefore, swimmers and beach goers are left with the choice of potentially getting personal items wet, or leaving their personal items unattended. Furthermore, those who frequent nightclubs, in particular females, generally lack adequate places to store personal items, including valuables. A purse or wallet is of limited use in such situations, because these items are likely to get lost or misplaced in crowded nightclubs. Furthermore, pockets may be completely absent from most nightclub-appropriate clothing. While it is possible to check personal items and valuables at nightclubs, there is no guarantee that the personal items and valuables will be safely returned to the individual who checked these items.

United States Application Publication No. 2005/0133130, which is fully incorporated by reference herein, discloses a personal storage device including a container associated with an attachment part, the container has an accessible interior space, and the attachment part is removably affixable to skin. The attachment part of the personal storage device has an adhesive on its surface.

U.S. Pat. No. 4,602,390 to Morera et al., which is fully incorporated by reference herein, discloses an independent pocket for incorporating into any kind of clothing, that includes at least two layers of material joined together, a heat sensitive adhesive layer that takes up at least part of one of the two layers of material positioned furthest back, the heat sensitive adhesive layer is secured to the material and to the article of clothing by the application of heat, and means of opening and closing the pocket thus formed which are located on one of the layers and/or on the joining edge between them.

U.S. Pat. No. 4,266,300 to Partridge, which is fully incorporated by reference herein, discloses an attachable and detachable pocket for a garment including a flat back portion having a front portion secured thereto together with a panel connected to the upper portion of the back portion with a portion thereof extended beyond the back portion. The extended portion has a pressure sensitive adhesive surface, and a releasable cover member for the pressure sensitive adhesive surface.

Therefore, there exists a need for a storage device that is capable of holding, storing and carrying personal items, and other items when use of pockets, wallets or purses is not suitable, and to overcome the limitations of known containers for personal items.

### SUMMARY OF THE INVENTION

In order to solve the problems mentioned above, the present invention features a reusable storage patch having at least a main pocket part and an affixing part attached thereto, which may be removed and re-affixed multiple times. The main pocket part includes one or more pocket parts, and may be constructed using gussets, pleats, or other sewing techniques to cater to the design and holdability of each pocket patch. Each storage patch is formed to hold and/or carry at least one personal item, such as credit and debit cards, cash and currency, perfume, makeup (e.g. lipstick or mascara), a driver's license, i.e. personal identification cards, and the like. The main pocket part may include a means for opening/closing the one or more pocket parts, and may also include a surface part having a decoration, design or the like thereon. In operation, the reusable storage patch may be affixed on an object, removed from the object, and re-affixed on the object or to another object.

The reusable storage patch may come is a variety of sizes, colors, patterns, etc., and may be designed for uses targeted to a variety of different markets from toddlers to seniors, men to women, different lines for different demographics, etc. For example, for ages 4-12, the storage patch may be used to hold lunch money; for ages 50+ it may be used as a pill pouch, for ages 15-50, the storage patch may be used as a body patch for the beach or clubs. It may also be patched on to shoes, clothes, and electronic devices.

The affixing part may include many different types or kinds of means for reusably affixing one item to another item either now known or later developed in the future, including, but not limited to, adhesive tape having a cover that may be removed for exposing the adhesive, like a bandaid, transfer tape, and double coated adhesive. The means for reusably affixing may also include a two-sided adhesive tape, magnets, snaps, Velcro, etc. The reusable storage patch is intended to be put on and taken off over and over again like a bandaid, and to have replacement tapes/backings sold separately/additionally for extensive uses.

According to an exemplary embodiment of the present invention, a reusable storage patch is provided that may include a storage device comprising at least one compartment, and a plurality of adhesive layers coupled to the storage device.

In an aspect of the embodiment of the present invention, each adhesive layer of the plurality of adhesive layers may be removable from the plurality of adhesive layers.

In an aspect of the embodiment of the present invention, the plurality of adhesive layers are each separated by a non-adhesive material.

In an aspect of the embodiment of the present invention, the plurality of adhesive layers are reusably affixable to at least one surface.

In an aspect of the embodiment of the present invention, the plurality of adhesive layers are configured to affix the reusable pocket to a surface, and to allow removal of the reusable pocket from the surface.

In an aspect of the embodiment of the present invention, the plurality of adhesive layers are configured to affix the reusable pocket to a first surface, and to a second surface after the reusable pocket is removed from the first surface.

In an aspect of the embodiment of the present invention, the plurality of adhesive layers comprise medical grade adhesive.

In an aspect of the embodiment of the present invention, each adhesive layer of the plurality of adhesive layers is reusably affixable to at least one surface.

In an aspect of the embodiment of the present invention, the plurality of adhesive layers comprises at least one layer of loop and hook fasteners.

In an aspect of the embodiment of the present invention, at least one adhesive layer of the plurality of adhesive layer comprises a first adhesive side and a second adhesive side.

In an aspect of the embodiment of the present invention, the storage device comprises a closure mechanism configured to substantially close the at least one compartment.

In an aspect of the embodiment of the present invention, the storage device comprises a flap extending at least partially over an opening of the at least one compartment.

In an aspect of the embodiment of the present invention, the closure mechanism is comprised of a snap, zipper, hook-and-loop fasteners, magnet or button.

In an aspect of the embodiment of the present invention, the storage device further comprises a key retaining device.

In an aspect of the embodiment of the present invention, the storage device is at least partially water resistant.

In an aspect of the embodiment of the present invention, the storage device is waterproof.

In an aspect of the embodiment of the present invention, the storage device is fabricated from natural fibers, synthetic fibers, vinyl, plastic, nylon or leather.

In an aspect of the embodiment of the present invention, the storage device further comprises at least one solar panel.

In an aspect of the embodiment of the present invention, the storage device is dimensioned to receive at least one personal item.

In an aspect of the embodiment of the present invention, the storage device is configured to removably affix to at least one surface via the plurality of adhesive layers.

One advantage of the present invention is that it provides a simpler, easier, quicker and versatile way to pocket and hold things.

The foregoing and other objects, features and advantages of the present invention will become more apparent in light of the following detailed description of exemplary embodiments of the invention.

### BRIEF DESCRIPTION OF THE DRAWINGS

The following drawings are not to scale and are presented to aid in the understanding of the present invention, in which:

FIG. 1 is an exemplary embodiment of the storage patch according to the present invention.

FIGS. 1a-1e demonstrate various uses of the storage patch and the surfaces to which the storage patch may be removably affixed to.

FIG. 1f is a cross-sectional view of an exemplary embodiment of the storage patch according to the present invention.

FIG. 1g is a cross-sectional view of another exemplary embodiment of the storage patch according to the present invention.

FIGS. 1h and 1i show exemplary embodiments of waterproof or water resistant storage patches according to the present invention.

FIG. 2 is an exemplary embodiment of the storage patch with multiple compartments removably affixed to an electronic device.

FIG. 3 provides various designs and embodiments of the storage patch according to the present invention.

FIGS. 4a-9c show various exemplary embodiments of the storage patch according to the present invention.

FIGS. 10-11 show various exemplary embodiments of the storage patch and exemplary objects to which the storage patches may be removably affixed to.

FIGS. 12a-13f show various exemplary embodiments of the storage patch according to the present invention.

FIGS. 14a and 14b show a flowchart of the design evolution of the packet patch by the inventor, including the sales plan, basic design information, the product, the business plan, the main idea and development.

### DETAILED DESCRIPTION OF THE INVENTION

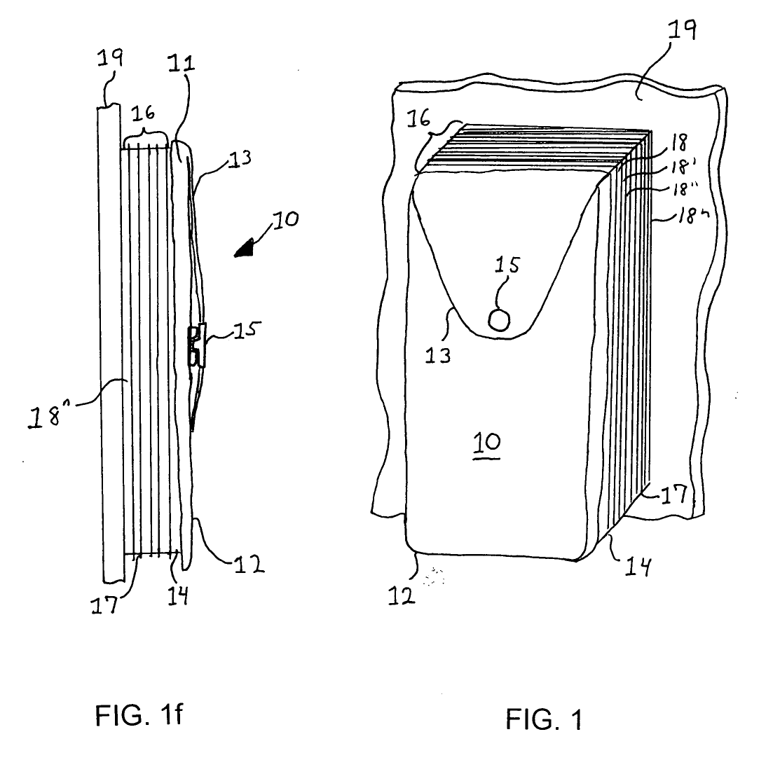

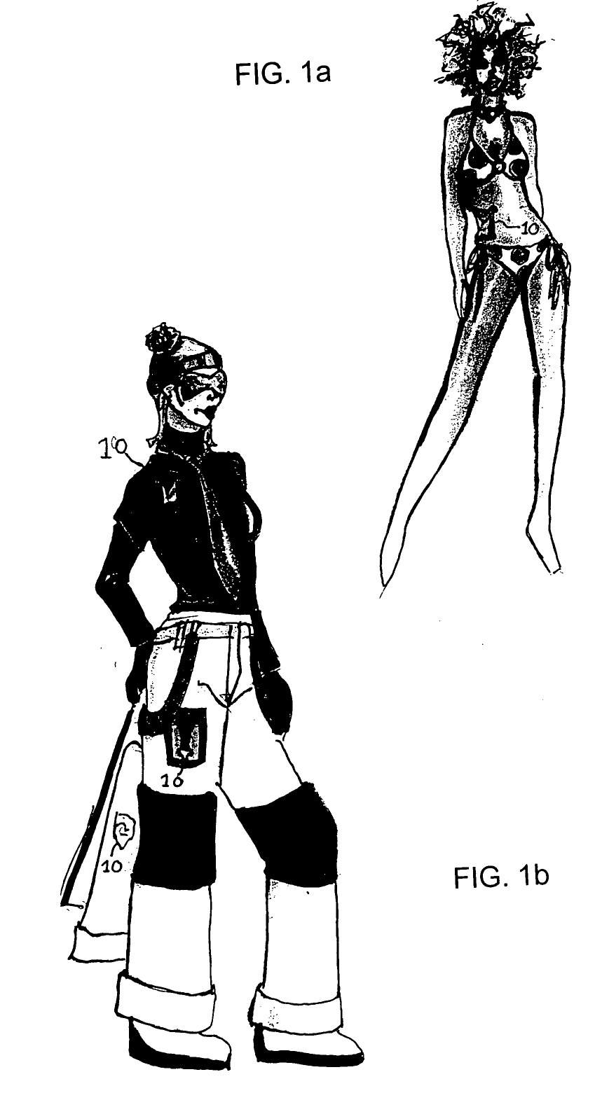

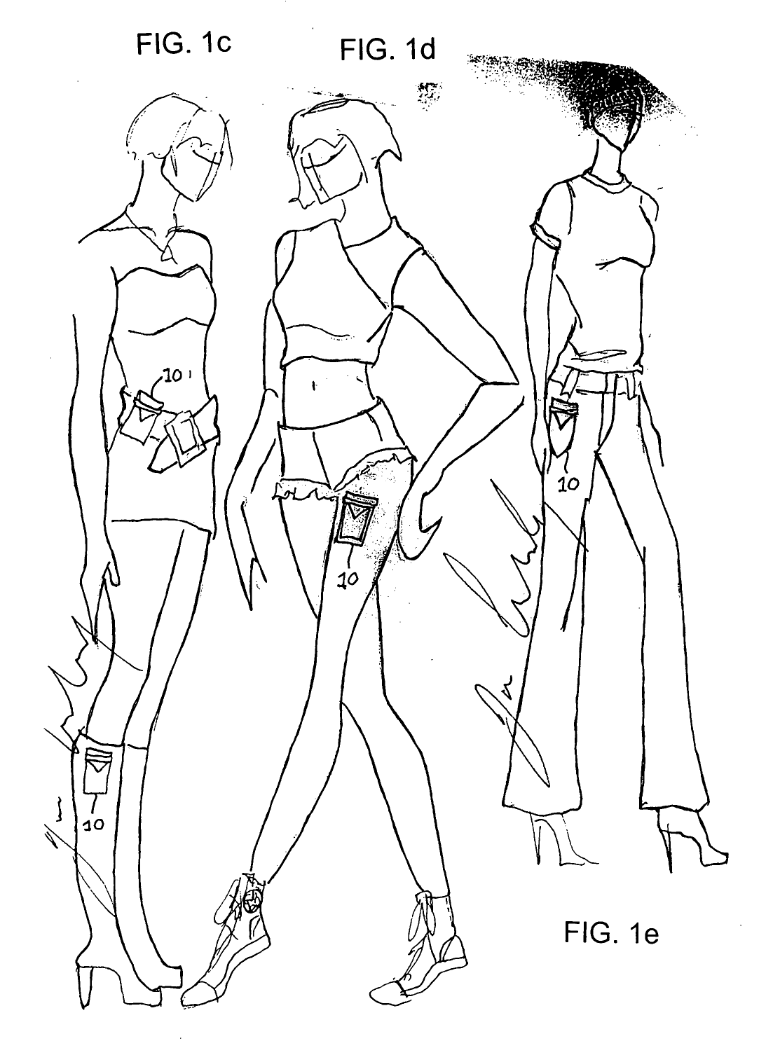

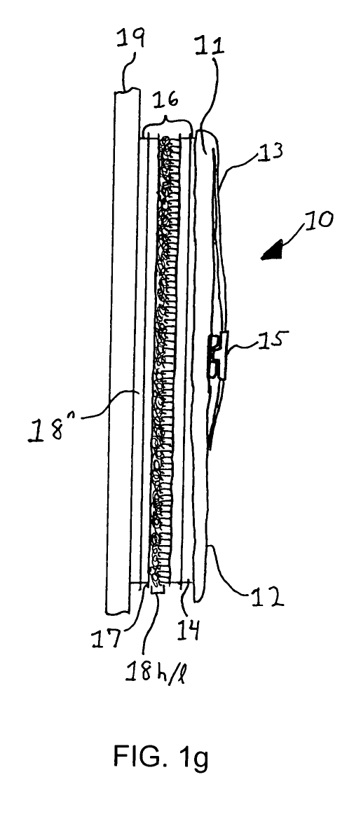

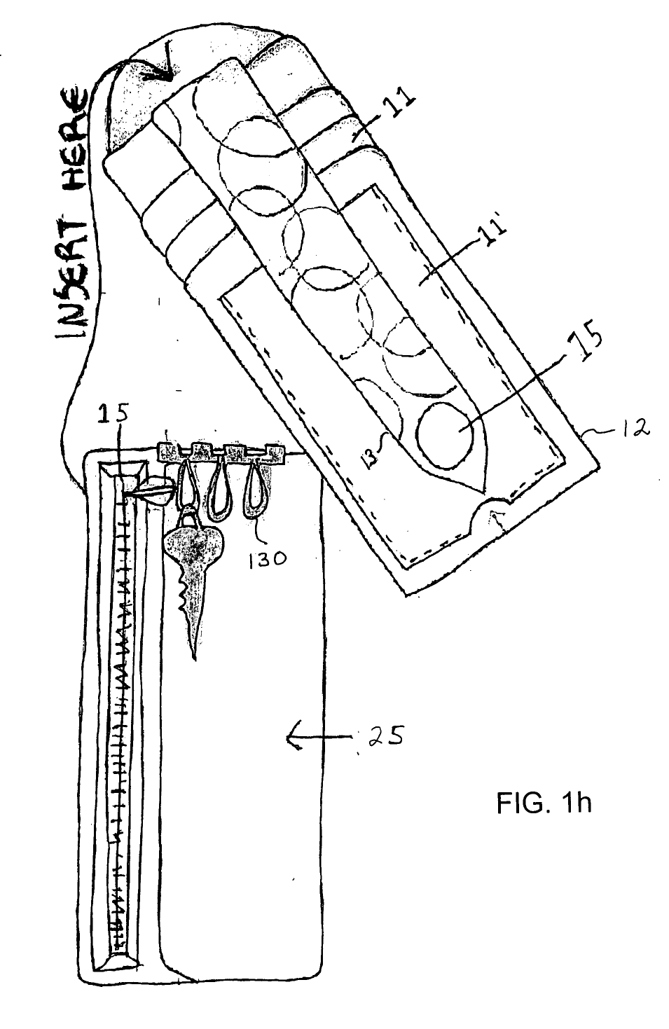

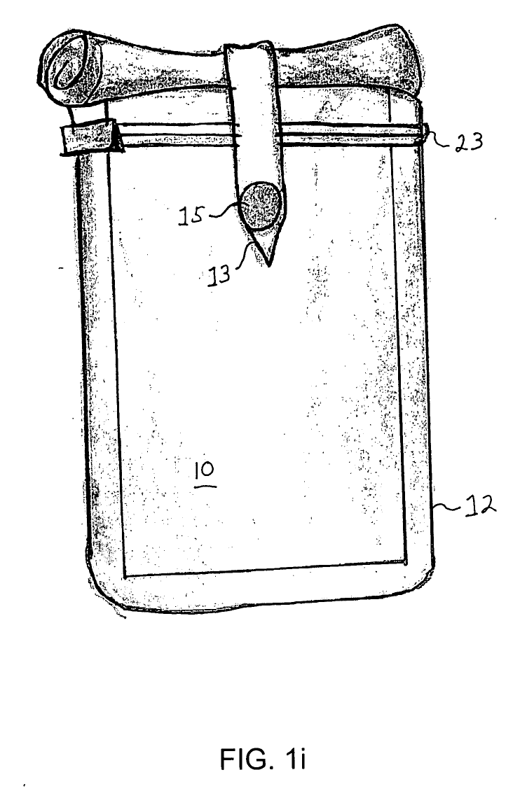

FIG. 1 shows an exemplary embodiment of the present invention in the form of a storage patch 10, in which the storage patch 10 includes a storage container 12 with at least one compartment. The storage container 12 may be in the form of a pocket, pouch, sack, bag, sleeve, sheath, envelope, or the like, and may be for example of single-part or multiple part construction. It is understood that the storage container 12 may include multiple interior compartments, for example pockets. The storage container 12 may include a flap 13 that covers an opening or openings of the compartment or compartments. The opening or openings may be formed in the storage container 12 by leaving an edge of the storage container unjoined, or by producing a slit or other aperture in the storage container 12. As shown in FIG. 1, the opening of the storage container 12 is covered by the flap 13.

The flap 13 may be secured to the storage container 12 to effect at least partial closure of the interior compartment or compartments by a closure mechanism 15. The closure mechanism 15 may be a snap, magnet, magnetic snap, button, hook-and-loop fasteners, i.e. what is commonly referred to as velcro. Instead of, or in addition to, the flap 12 and closure mechanism 15, the interior compartment may be closed by a zipper in one aspect of the exemplary embodiment of the present invention, or the closure mechanism 15 itself may include a zipper. The reusable storage patch 10 may include many different types or kinds of closure mechanisms for opening/closing the storage container 12 either now known or later developed in the future. For example, means for opening/closing the storage container 12 may include a button, a zipper, Velcro, a zip lock, a magnet, a snap lock, etc. The scope of the invention is not intended to be limited to the type or kind of means for opening/closing the storage container 12 either now known or later developed in the future.

According to an exemplary embodiment of the present invention the storage container 12 is dimensioned to receive and hold personal items, such as credit and debit cards, money or currency, personal identification, i.e. driver's licenses or passports, makeup, keys, and the like. However, it is understood that the scope of the invention is not limited to storage containers for receipt and storage of personal items, but rather the storage container 12 may be dimensioned to receive and store a variety of items, such as sports related items, photography related items and/or school or academic related items. For example a non-limiting list of items, including personal items, that the storage patch 10 may be used to hold includes, tickets, identification cards, i.e. driver's licenses, medications, i.e. pills, etc., eyewear, i.e. glasses, sunglasses, contact lenses, watches and other time pieces, condoms, perfumes and colognes, jewelry, breath mints, gum, candy, writing instruments, hand creams and lotions, mirrors, electronic devices, notepads, checkbooks, calendars and any other items. It is understood that the storage patch 10 may include one or more storage containers 12 specifically designed for receipt of one or more of the exemplary items mentioned above, but the scope of the invention is not limited storage containers that are designed to receive specific items. Instead, the scope of the invention includes storage containers that are dimensioned to receive any personal or other items now known or later developed.

The pocket patch 10 shown in FIG. 1 may include a plurality of adhesive layers 16 that allow the pocket patch 10 to be removably affixed to a variety of surfaces 19. For example, the plurality of adhesive layers 16 may be affixed to and removed from plastics, skin, fabrics, i.e. clothing, leather, and other surfaces. A medical grade adhesive may be used for the plurality of adhesive layers 16. Each adhesive layer 18 of the plurality of adhesive layers may be removed from and applied to a surface or multiple surface a number of times. The scope invention is not intended to be limited by the number of times each adhesive layer 18, 18′, 18″, 18ⁿ of the plurality of adhesive layers 16 are reusable. It is understood that the type of adhesive material used, and the surface the adhesive is applied to may affect the number of times each adhesive can be used before a new adhesive layer should be used.

The adhesive used for each plurality of adhesive layers 18, 18′, 18″, 18ⁿ may be pressure sensitive, i.e. adheres to a surface when pressure is applied, or heat activated. The adhesive layers may be made from adhesive that can be applied to wet or dry surfaces, and/or remain affixed to surfaces that may become wet. The is plurality of adhesive layers 16, i.e. affixing part, may include many different types or kinds of means for reusably affixing one item to another item either now known or later developed in the future, including, but not limited to, adhesive tape having a cover that may be removed for exposing the adhesive, like a bandaid, transfer tape, double coated adhesive, and/or double sided adhesive. For example, the adhesive may be 7 mil double-sided pressure sensitive adhesive tape. The type of adhesive used may be sweatproof, water resistant, and/or waterproof. The type of adhesive used may be such that the adhesive does not remove hair. The adhesive may be a medical grade adhesive, for example a medical grade adhesive that is hypoallergenic or other type of adhesive that is hypoallergenic. The affixing part may also include a two-sided adhesive tape, magnets, snaps, Velcro, etc or any combination of these means for removably affixing. The storage patch 10 is intended to be put on and taken off over and over again, and to have replacement tapes/backings for extensive uses. It is understood that the plurality of adhesive layers 16 may be formed from different types of adhesives, and the scope of the invention is not limited to a plurality of layers made from the same type of adhesive. It is understood that FIG. 1 is not drawn to scale, and that the plurality of adhesive layers 16 may be only a few millimeters depending on the type of adhesive material used.

Between one or more of the adhesive layers there may be a non-adhesive film 17 that is releasable from the adhesive layers. An adhesive layer, i.e. 18 may be removed from the film 17, or the film 17 may be removed from the adhesive layer, i.e. 18, for example by peeling the film 17 or adhesive layer away from each other. However, the non-adhesive film 17 is sufficiently adhered to by the adhesive layer, so that when the outermost adhesive layer 18ⁿ is releasably affixed to a surface 19 the outermost adhesive 18ⁿ layer does not separate from the non-adhesive film 17. The non-adhesive film 17 may be a film of plastic, rubber, teflon, wax paper or other suitable non-adhesive material.

The plurality of adhesive layers 16 and storage container 12 may be attached together by a coupling 14. The coupling 14 may be one of the adhesive layers adhered to the storage container 12. Alternatively, or in addition, the coupling 14 may be a surface attached to the storage container 12 that allows one of the plurality of adhesive layers, i.e. 18 to be releasably affixed to the surface attached to the storage container 12. In this manner, the plurality of adhesive layers 16 may be replaced after an individual has removed all of the adhesive layers.

The storage container 12 may be made from many different types and kinds of materials. For example, the materials may include a natural material like cotton, silk, etc, as well as a manmade or synthetic material like a plastic (clear or opaque), nylon, rayon, etc. In accordance, the storage patch 10 may be heat sealed or sewn, depending upon the fabric choices. The materials or construction of the storage patch 10 may be waterproof and/or water resistant. For example, the storage patch 10 may be made from vinyl, coated leathers, nylon, plastics or other materials that are waterproof or water resistant. FIGS. 1h and 1i show exemplary embodiments of the storage patch that may be constructed so as to be waterproof or water resistant. FIG. 1h shows an exchangeable outer case 12 that may be water resistant or waterproof that is dimensioned for receipt of an interior detachable waterproof or water resistant pocket 25. The interior detachable pocket 25 may be inserted and removed from the outer case 12. FIG. 1i shows an exemplary embodiment of a waterproof or water resistant storage patch 10 that includes a double ziploc enclosure 23. The scope of the invention is not intended to be limited to the type or kind of material that storage patch 10 is made of either now known or later developed in the future.

FIG. 1f shows a cross-sectional view of the storage patch 10 of FIG. 1. The storage patch 10 shown in FIG. 1f includes an interior compartment 11, i.e. pocket within the storage container 12. The closure mechanism 15 of the exemplary embodiment of FIG. 1f is a snap or a magnetic snap, however the scope of the invention is not limited to any particular closure mechanism. The plurality of adhesive layers 16 allows the storage patch 10 to be removably affixed to the surface 19.

FIG. 1g shows a cross-sectional view of an exemplary embodiment of the storage patch 10, in which within the plurality of adhesive layers 16 includes at least one layer of loop-and-hook fasteners 18h/l. The at least one layer of loop-and-hook fasteners 18h/l may be positioned at any location within the plurality of adhesive layers 16. In one aspect of the present invention, the layer of loop-and-hook fasteners 18h/l may act as the coupling 14 between the plurality of adhesive layers 16 and the storage container 12. In this aspect of the invention, one side of the loop-and-hook fasteners 18h/l may be attached to the storage compartment, by sewing for example, and the other side may be removably affixed to the plurality of adhesive layers 16. In this manner, the storage container 12 may be transferred between multiple pluralities of adhesive layers 16 without having to potentially degrade the adhesive layers by removing and reapplying the adhesive. The at least one layer of loop-and-hook-fasteners 18h/l may itself be releasably affixed to a layer of the plurality of adhesive layers 16, or it may be permanently affixed to one of the adhesive layers. It is understood that the scope of the invention is not limited by the means by which the plurality of adhesive layers 16, including any loop-and-hook fastener layers 18h/l are affixed to each other.

FIGS. 1a through 1e show a variety of surfaces to which exemplary embodiments of the storage patch 10 may be removably affixed. FIG. 1b shows an individual wearing three storage patches 10 on various articles of clothing, including a sweater and scarf. FIG. 1c shows an individual in swim wear or beach attire, and the storage patch 10 has been removably affixed to that individual's skin. FIG. 1c shows one storage patch 10 removably affixed to an individual's belt that may be made of leather, vinyl, pleather or another material commonly used in the manufacture of belts. FIG. 1c also shows a second storage patch removably affixed to the individual's boots, which may be made from leather or other material commonly used in the manufacture of boots. It is understood that the scope of the invention is not limited to the surface that an embodiment of the storage patch may be applied to.

FIG. 1d shows a storage patch 10 removably affixed to skin, and FIG. 1e shows a storage patch 10 removably affixed to a pair of pants, which may be made from denim or other suitable material. In addition to the surfaces shown in FIGS. 1a through 1e storage patch 10 may be affixed on many different types or kind of objects and surfaces and used for a variety of purposes. For example, the objects may include clothing of a person like jeans, shorts, socks, hats, shirts, boots; the skin of a person like the arm, torso, leg; a pocketbook or carry bag of a person; a cell phone, IPOD, CD player, tape player, the side of a tool (e.g. a drill to hold drill bits); machinery or equipment; the dashboard of a car, school books, notebooks, laptops, crafts, etc. The scope of the invention is not intended to be limited to the type or kind of object that the reusable storage patch 10 is affixed.

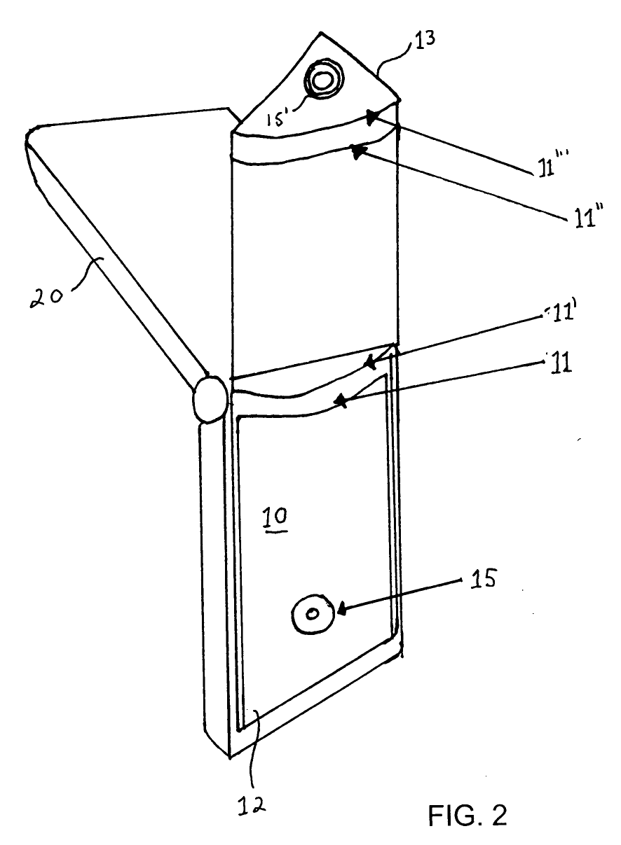

FIG. 2 shows an exemplary embodiment of the storage patch 10 that is removably affixed to an electronic device 20, for example a cellular telephone. The electronic device 20 may be any variety of personal electronic devices, such as cellular telephones, portable music players, personal data assistants (PDA), or the like. The storage patch 10 shown in FIG. 2 includes a first interior compartment 11, a second interior compartment 11′, a third 11″ and fourth 11′″ interior compartments that may be located in the flap 13 of the storage container 12.

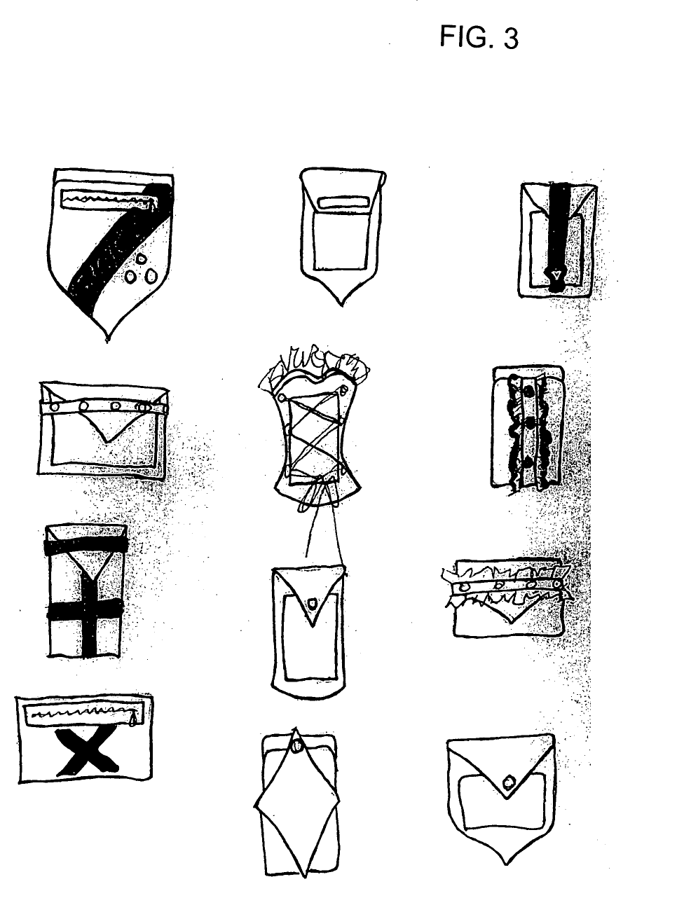

FIG. 3 shows various exemplary embodiments of the storage patch 10. It is understood that the invention is not limited to any shape, configuration or design of the storage patch 10, but instead may include any shape, configuration or design, including for example those shapes, configurations and designs shown in FIG. 3. It is understood that the storage patch 10 may have various words, designs, slogans or symbols on its exterior, as seen in FIG. 3 for example. The storage patch 10 may include decorations, designs or the like thereon, including a copyrightable work of art, a company trademark, company logo, or the like. The decorations and/or designs may include a pattern, a picture, a logo, a letter, a word, a number, a graphical design or symbol, advertising message, or the like, either solely or in any combination. The copyrightable works of art, the company trademark, the company logo would enable exclusive distribution of the reusable storage patch in sales promotions and the like by or for a company.

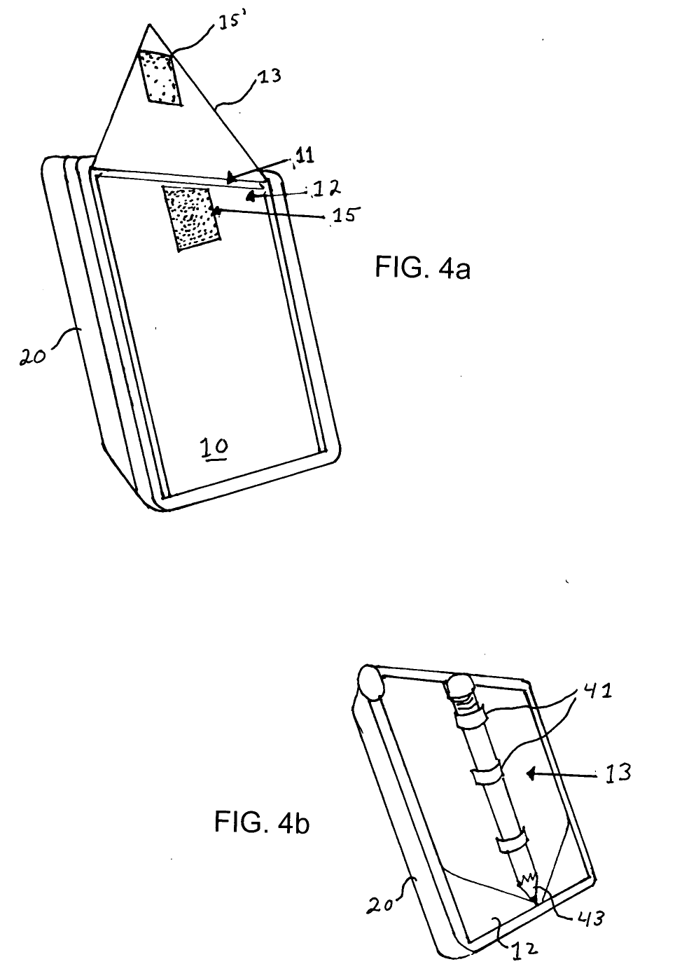

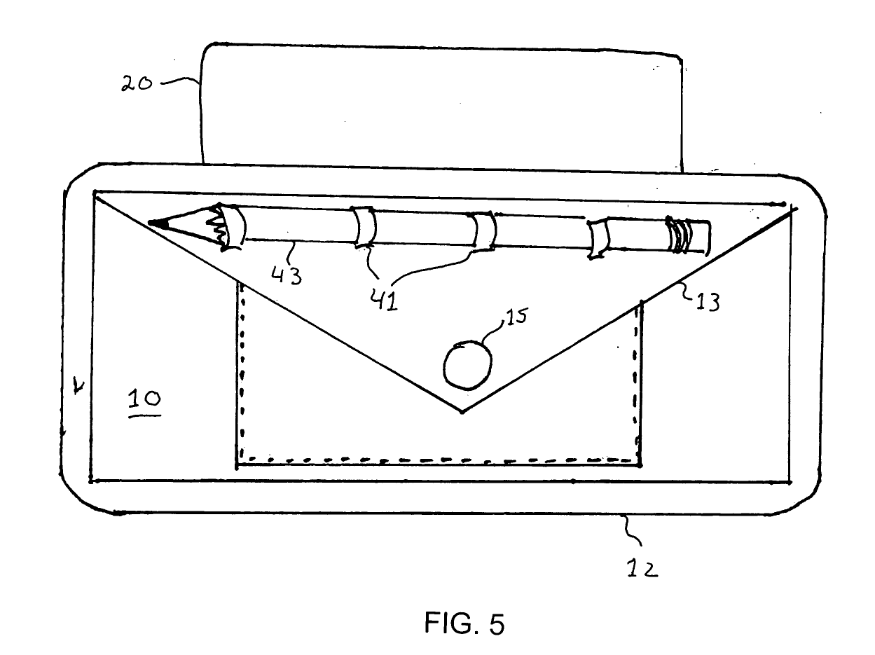

FIG. 4a shows another exemplary embodiment of the storage patch 10 according to the present invention. The storage patch 10 shown in FIG. 4a is removably affixed to a personal electronic device 20, and includes loop-and-hook fasteners 15, 15′ as its closure mechanism. The storage patch 10 shown in FIG. 4b is also removably affixed to a personal electronic device 20, i.e. a cellular telephone, and may include one or more loops 41 for holding an object 43 such as a writing instrument. The writing instrument may be a pen, pencil, marker, highlighter or the like. The one or more loops 41 may be made from the same material or a different material as the flap 13. The one or more loops 41 may be made from an elastic material that is configured to stretch in response to an applied force, and return to its original configuration upon the removal of the force.

FIG. 5 shows another exemplary embodiment of the storage patch 10 according to the present invention. The storage patch 10 may be removably affixed to an electronic device 20, for example a personal data assistant (PDA) as shown in FIG. 5. The opening to the interior compartment of the storage container 12 may be on a long edge of the storage container 12, and the flap 13 may be positioned accordingly. It is understood that the shape of the storage patch 10 is not limited to rectangular configurations, but instead can be any shape or configuration. The storage patch 10 may include many different types and kinds of shapes. For example, the shapes may include any kind of geometric shape, such as square, round, triangular, etc., as well as a heartshape. The scope of the invention is not intended to be limited to the type or kind of shape either known or later developed in the future.

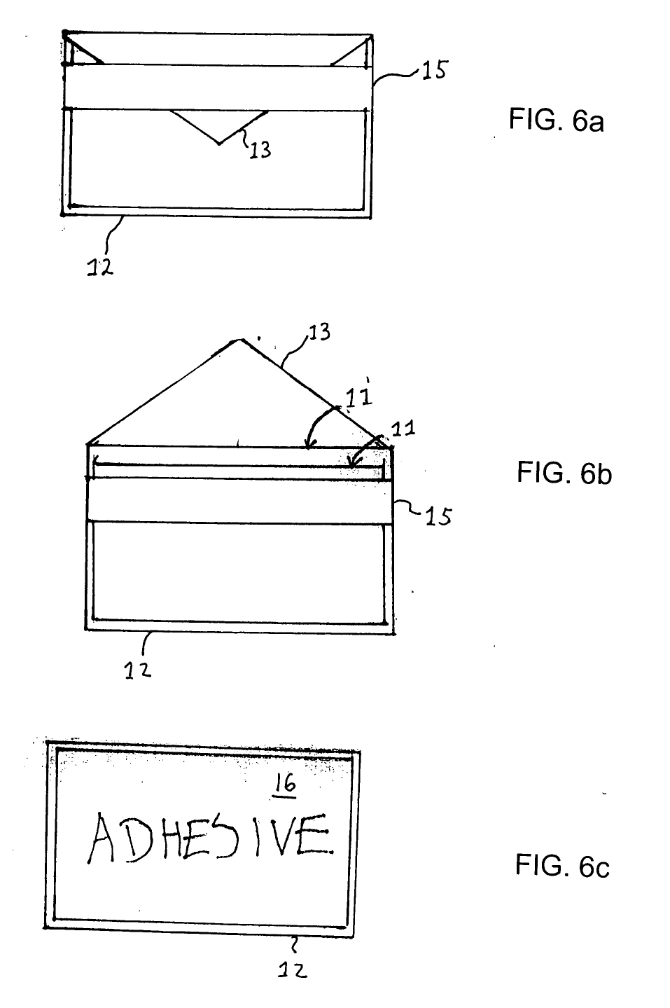

FIG. 6a shows a front perspective of an exemplary embodiment of the storage patch 10 that includes a strap as the closure mechanism 15. The strap may be configured to allow the flap 13 to be slid under the strap, and thereby retained. FIG. 6b shows the exemplary embodiment of the storage patch 10 of FIG. 6a with the flap 13 in an open position. The storage patch 10 shown in FIG. 6b contains a first interior compartment 11 and a second interior compartment 11′. FIG. 6c shows a back view of the storage patch 10 shown in FIG. 6a, and displays the outermost layer of the plurality of adhesive layers 16.

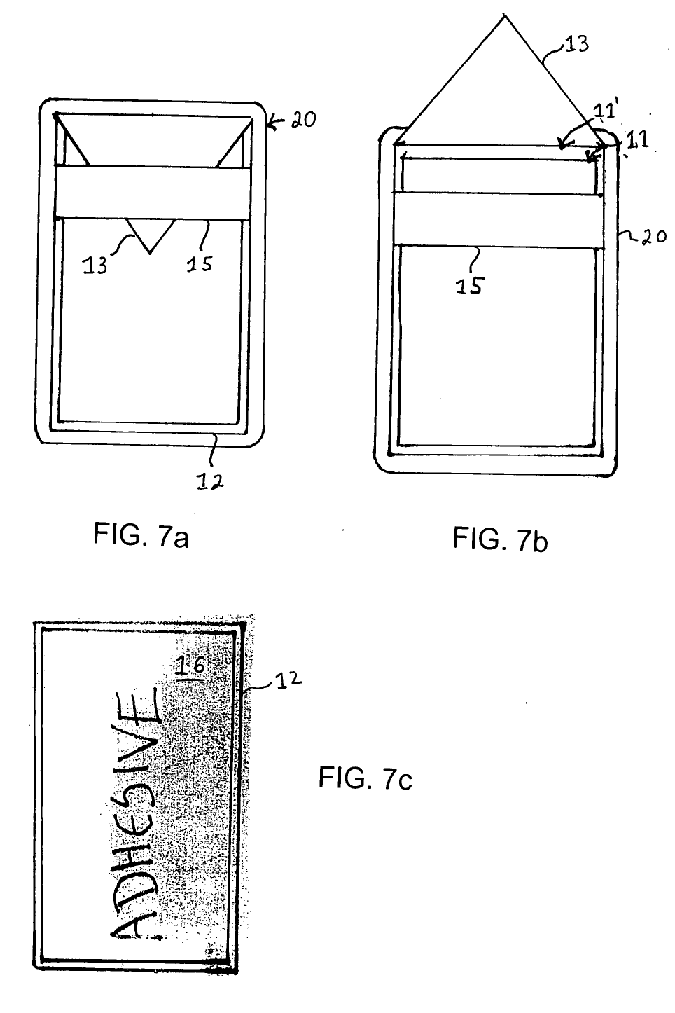

FIGS. 7a through 7c show an exemplary embodiment of the storage patch 10 according to the present invention, in which the openings for the interior compartments 11, 11′ of the storage container 12 are on a short side of the storage container 12. The storage patch 10 may also include a strap as the closure mechanism 15. The strap may be made from any material, including the material or materials that make up the storage container 12.

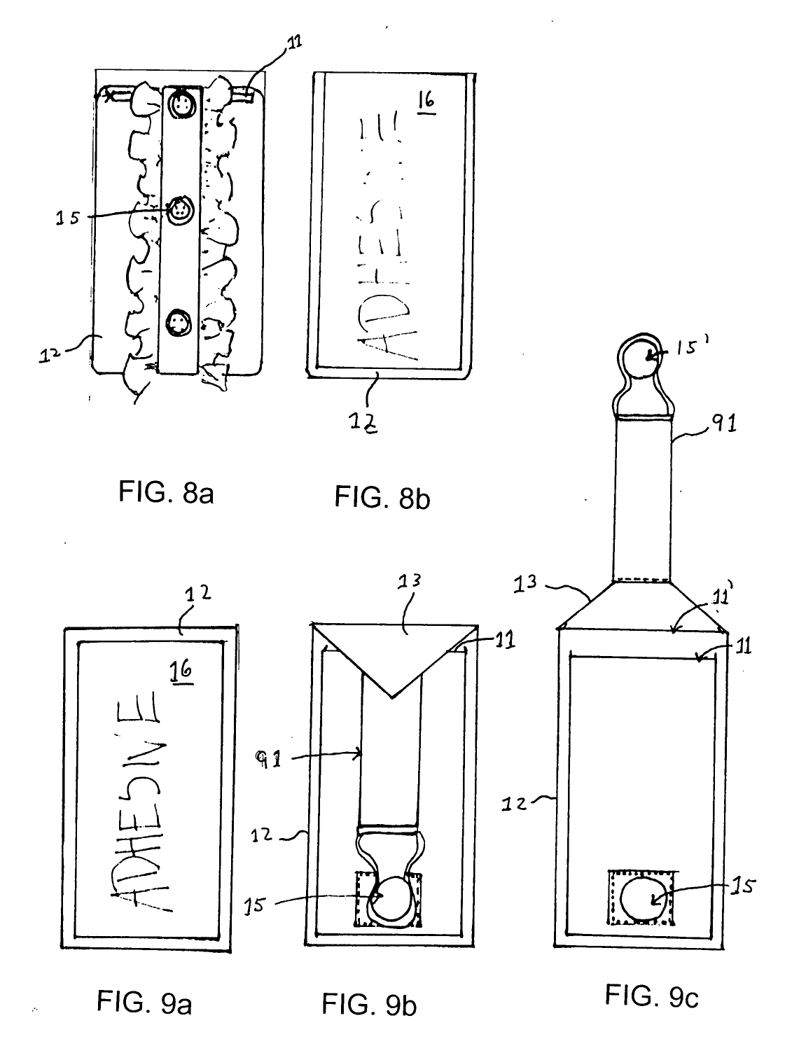

FIGS. 8a and 8b show an exemplary embodiment of the storage patch 10, in which the closure mechanism 15 is at least one button. FIGS. 9a through 9c show an exemplary embodiment of the storage patch 10, in which the closure mechanism 15 is a magnet operatively coupled to the flap 13 by a strap 91. The strap 91 may be comprised of an elastic material, or other material capable of stretching and substantially returning to its original configuration, for example a spandex type material.

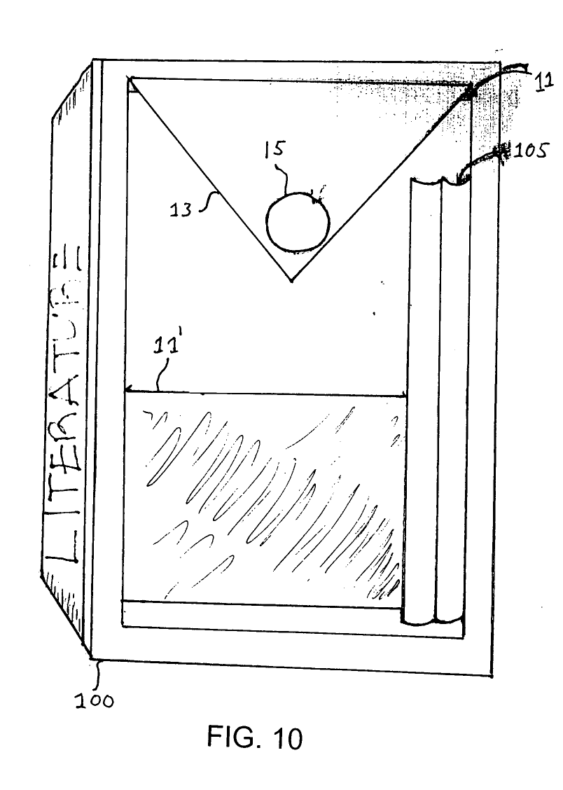

FIG. 10 shows an exemplary embodiment of the storage patch 10 removably affixed to a piece of literature 100, i.e. a book. The storage patch 10 shown in FIG. 10 may include a first compartment 11 and a second compartment 11′ that is located on the exterior of the storage container 12 comprised of the first compartment 11. The scope of the invention is not intended to be limited to interior compartments that are located within the storage container 12, but it is understood that the storage container 12 may be comprised of a number of compartments at various locations. It is also understood that the storage patch 10 may include multiple storage containers 12. The second compartment 11′ may be comprised of a clear or transparent material, such as a plastic. The storage patch 10 may also include at least one compartment for holding or storing a writing instrument, such as a pen, pencil, marker, highlighter or the like.

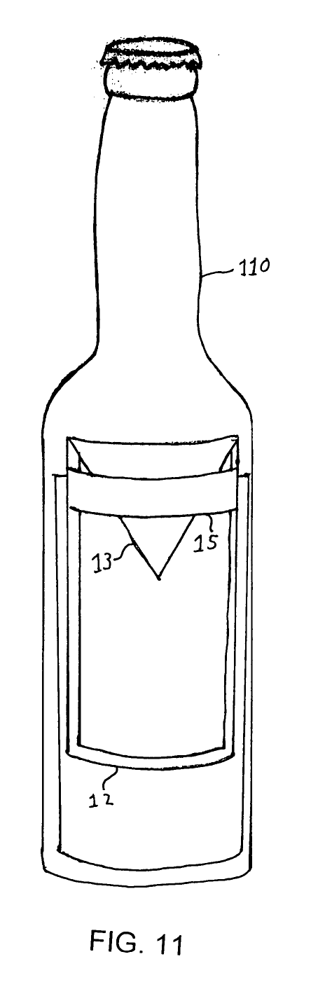

FIG. 11 shows an exemplary embodiment of the storage patch 10 removably affixed to a bottle 110, for example a glass bottle.

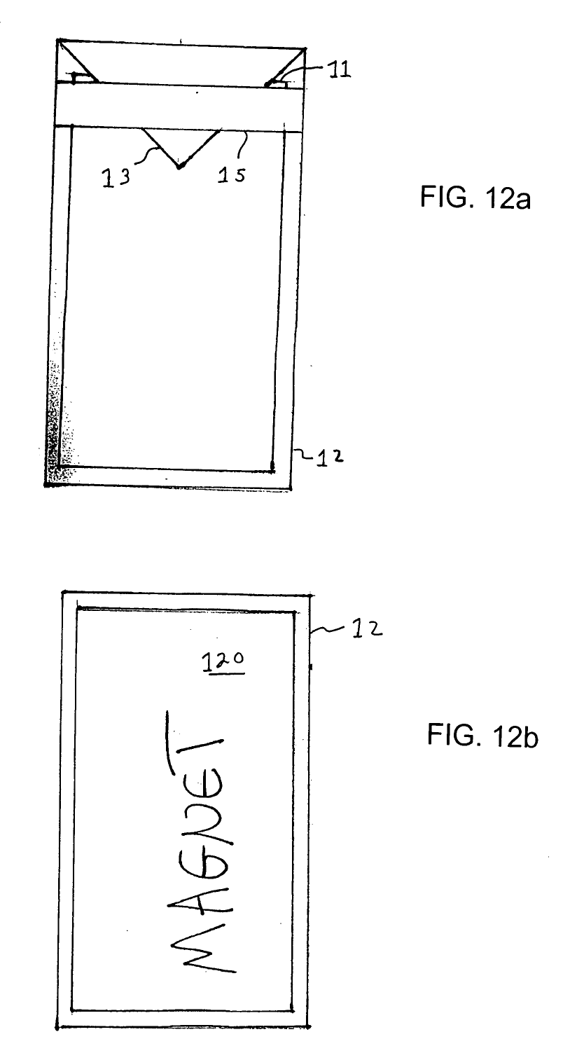

FIGS. 12a and 12b show an exemplary embodiment of the storage patch 10, in which in addition to the plurality of adhesive layers, or in alternative to, the storage patch 10 includes a magnet 120 so as to be removably affixed to surfaces. The magnet 120 may be coupled to the storage container 12, or may be included as part of the plurality of adhesive layers.

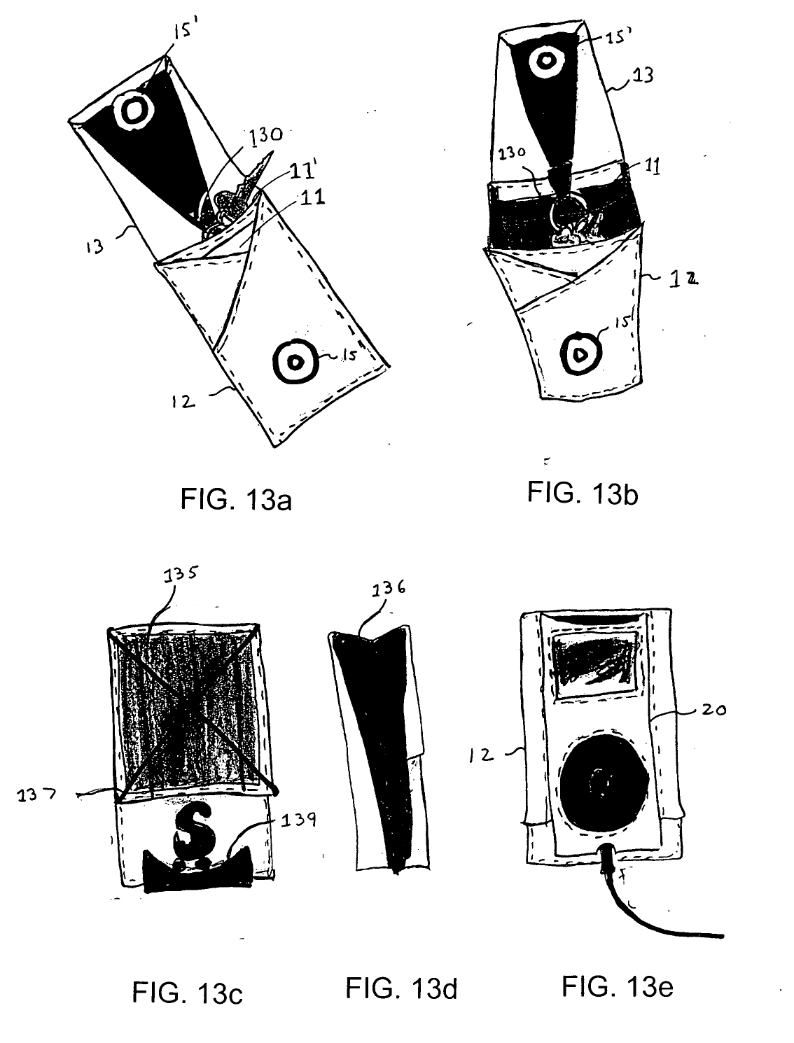

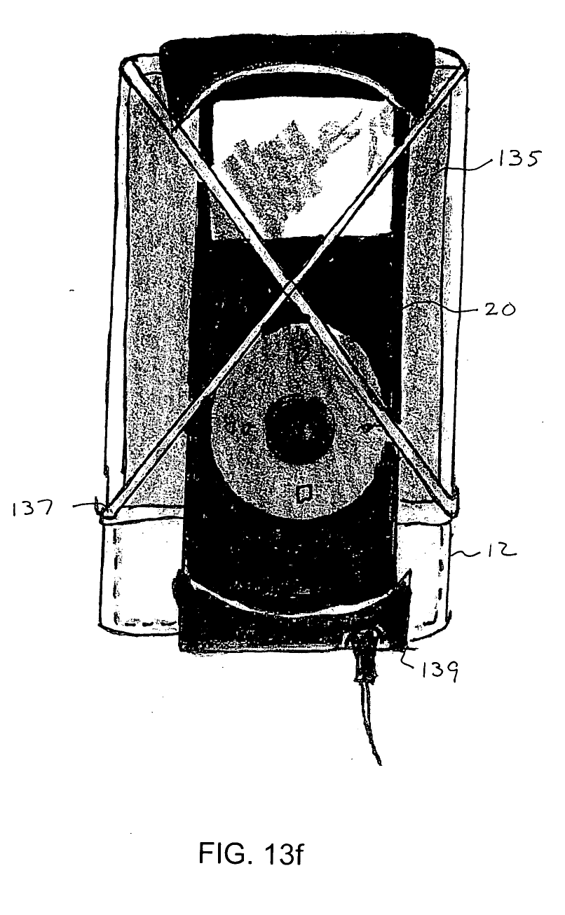

FIGS. 13a and 13b show an exemplary embodiment of the storage patch 10, in which the storage patch 10 includes a key ring 130 for retaining keys within or to the storage patch 10. FIGS. 13c and 13f show an exemplary embodiment of the storage patch 10 that includes a solar panel 137. The solar panel 137 may be configured to couple to an electronic device in order to provide for charging of the electronic device. The storage patch may also include one or more electronic device 20 retaining members 137, 139 in order to hold an electronic device while charging. Video cameras, MP3 players, IPODs, digital cameras, handheld gaming devices, batteries and cell phones, laptops, generator and the like we be able to be charged when secured to the storage patch 10. FIG. 13d shows an exemplary embodiment of the storage patch 10 that includes at least one side gusset 136. FIG. 13e shows an exemplary embodiment of the storage patch 10 coupled to a portable electronic device 20, for example a personal music player. The storage patch 10 may also be built into portable electronic devices, including internally on phones—IPOD—PDAs and computers—along with any other portable electronic device either now known or later developed in the future.

It is understood that although the present invention is discussed in relation to a device for storing items, for example personal items, the present invention includes any object whether it is configured to hold items or not that is reusably and removably affixed to at least one surface. For example, the object may include an identification badge or card with a plurality of adhesive layers or other means for reusably affixing the identification badge or card to one or more surfaces. The object may also be a personal accessory that may be removably affixed to or about an individual. It is understood that the present invention is not limited to any particular embodiment or configuration discussed above.

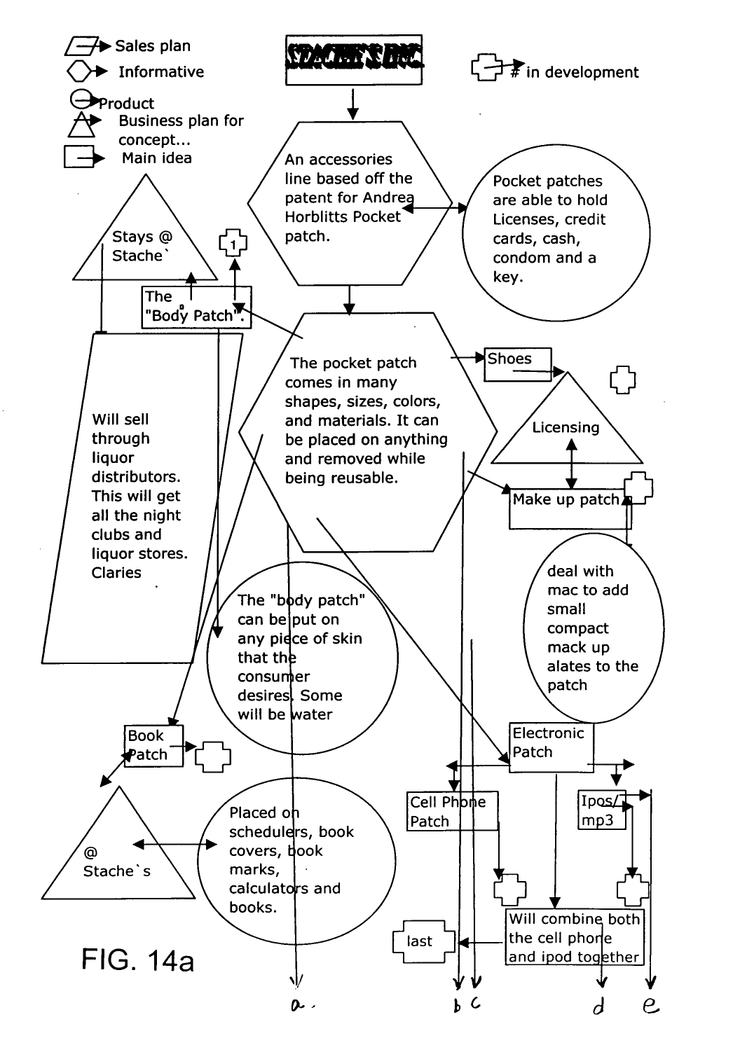

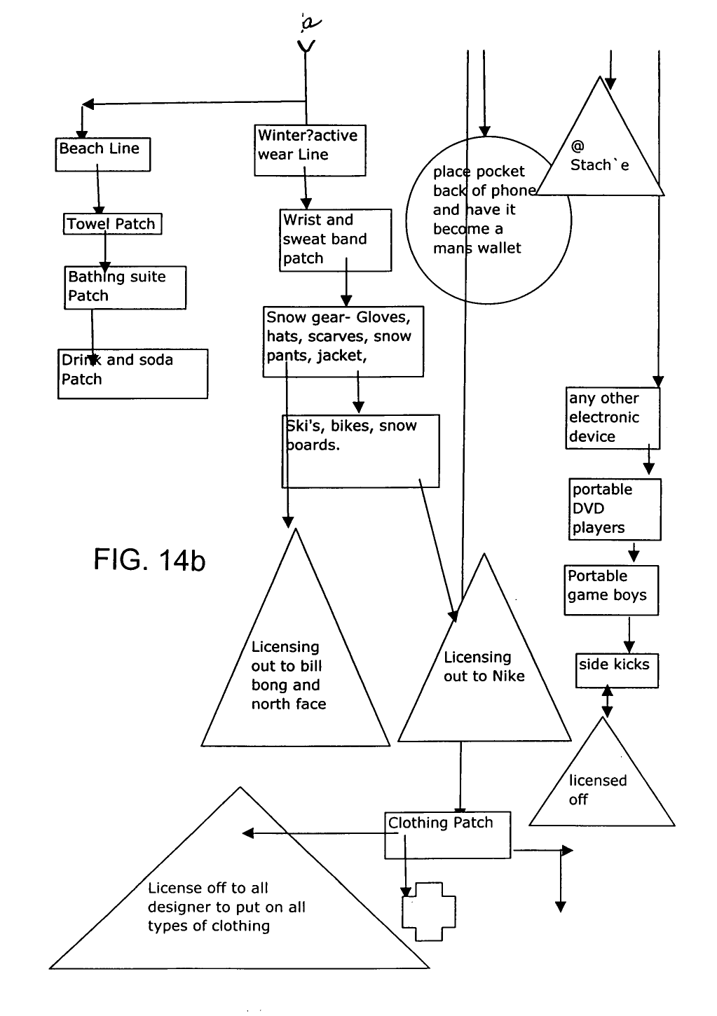

FIGS. 14a and 14b show a flowchart of the design evolution of the packet patch by the inventor, including the sales plan, basic design information, the product, the business plan, the main idea and development.

### The Scope of the Invention

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

What is claimed is:

1. An apparatus, comprising:
a storage device comprising at least one compartment; and
a plurality of adhesive layers coupled to said storage device.

2. The apparatus according to claim 1, wherein each adhesive layer of said plurality of adhesive layers is removable from said plurality of adhesive layers.

3. The apparatus according to claim 1, wherein said plurality of adhesive layers are each separated by a non-adhesive material.

4. The apparatus according to claim 1, wherein said plurality of adhesive layers are reusably affixable to at least one surface.

5. The apparatus according to claim 1, wherein said plurality of adhesive layers are configured to affix the apparatus to a surface, and to allow removal of the apparatus from said surface.

6. The apparatus according to claim 1, wherein said plurality of adhesive layers are configured to affix the apparatus to a first surface, and to a second surface after the apparatus is removed from the first surface.

7. The apparatus according to claim 1, wherein said plurality of adhesive layers comprise medical grade adhesive.

8. The apparatus according to claim 1, wherein each adhesive layer of said plurality of adhesive layers is reusably affixable to at least one surface.

9. The apparatus according to claim 1, wherein said plurality of adhesive layers comprises at least one layer of loop and hook fastener.

10. The apparatus according to claim 1, wherein at least one adhesive layer of said plurality of adhesive layer comprises a first adhesive side and a second adhesive side.

11. The apparatus according to claim 1, wherein said storage device comprises a closure mechanism configured to substantially close said at least one compartment.

12. The apparatus according to claim 11, wherein said storage device comprises a flap extending at least partially over an opening of said at least one compartment.

13. The apparatus according to claim 11, wherein said closure mechanism is comprised of a snap, zipper, hook-and-loop fasteners, magnet or button.

14. The apparatus according to claim 1, wherein said storage device further comprises a key retaining device.

15. The apparatus according to claim 1, wherein said storage device is at least partially water resistant.

16. The apparatus according to claim 1, wherein said storage device is waterproof.

17. The apparatus according to claim 1, wherein said storage device is fabricated from natural fibers, synthetic fibers, vinyl, plastic, nylon or leather.

18. The apparatus according to claim 1, wherein said storage device further comprises at least one solar panel.

19. The apparatus according to claim 1, wherein said storage device is dimensioned to receive at least one personal item.

20. The apparatus according to claim 1, wherein said storage device is configured to removably affix to at least one surface via said plurality of adhesive layers.

21. A reusable storage device, comprising:
a storage device comprising at least one compartment; and
a plurality of adhesive layers coupled to said storage device;
wherein said plurality of adhesive layers are reusably affixable to at least one surface; and
wherein at least one adhesive layer of said plurality of adhesive layers comprises medical grade adhesive.

22. A reusable storage patch, comprising:
a storage device comprising at least one compartment; and
a plurality of medical grade adhesive layers coupled to said storage device;
wherein each adhesive layer of said plurality of medical grade adhesive layers is reusably affixable to at least one surface;
wherein said plurality of medical grade adhesive layers are each separated by a non-adhesive material;
wherein said storage device comprises a flap extending at least partially over an opening of said at least one compartment; and
wherein said storage device comprises a closure mechanism configured to at least temporarily secure said flap to said storage device.
